(19) United States
(12) Patent Application Publication
(10) Pub. No.: US 2009/0044838 A1
(43) Pub. Date: Feb. 19, 2009

(54) OZONATION FOR ELIMINATION OF BACTERIA FOR WET PROCESSING SYSTEMS

(75) Inventors: Bruce Willing, Fairfield, CA (US); Daniel P. Forster, Los Altos, CA (US); David Datong Huo, Campbell, CA (US); Robert D. Tolles, San Jose, CA (US); Christopher L. Haynes, Newark, CA (US); Steven T. Mear, Austin, TX (US); David Paul, Georgetown, TX (US); William M. Evans, Cedar Park, TX (US)

Correspondence Address: DUGAN & DUGAN, PC, 245 Saw Mill River Road, Suite 309, Hawthorne, NY, 10532, US

(73) Assignee: Applied Materials, Inc.

(21) Appl. No.: 12/249,954

(22) Filed: Oct. 12, 2008

Related U.S. Application Data
(62) Division of application No. 11/525,532, filed on Sep. 22, 2006.
(60) Provisional application No. 60/719,769, filed on Sep. 23, 2005.

(51) Int. Cl. B08B 3/08

(52) U.S. Cl. 134/95.1; 134/94.1; 134/57 R

(57) ABSTRACT

In a first aspect, an apparatus adapted to clean a semiconductor device manufacturing component is provided. The apparatus includes an ozone module adapted to (1) obtain Ozone; (2) combine the Ozone with a fluid to generate ozonated fluid; and (3) deliver the ozonated fluid to the semiconductor device manufacturing component so as to clean the semiconductor device manufacturing component. Numerous other aspects are provided.

This application is a division of, and claims priority to, U.S. Non-Provisional patent application Ser. No. 11/525,532, filed Sep. 22, 2006, and titled, “OZONATION FOR ELIMINATION OF BACTERIA FOR WET PROCESSING SYSTEMS” (Attorney Docket No. 10540), which claims priority to U.S. Provisional Patent Application Ser. No. 60/719,769, filed Sep. 23, 2005, and titled, “OZONATION FOR ELIMINATION OF BACTERIA FOR WET PROCESSING SYSTEMS” (Attorney Docket No. 10540/L). Both of these patent applications are hereby incorporated by reference herein in their entirety for all purposes.

### FIELD OF THE INVENTION

The present invention relates to semiconductor device manufacturing, and more particularly to ozonation for the elimination of bacteria in a wet processing system.

### BACKGROUND OF THE INVENTION

Conventional cleaning systems may be used to remove slurry residue, contaminants and/or particulates or to otherwise clean a substrate following chemical mechanical polishing (CMP). For example, megasonic tanks, brush scrubbers, spin rinse dryers, Marangoni dryers, etc., may be used to clean a substrate post CMP.

After repeated use, such cleaning systems may themselves become dirty and/or contaminated (e.g., as a result of cleaning substrates within the cleaning systems). To prevent the cleaning systems from becoming contamination sources, the cleanings systems must be cleaned (e.g., periodically). Accordingly, efficient and cost effective techniques for cleaning or otherwise sanitizing cleanings systems are desirable.

### SUMMARY OF THE INVENTION

In a first aspect of the invention, a method of cleaning a semiconductor device manufacturing component is provided. The method includes the steps of (1) obtaining an ozonated fluid; (2) supplying the ozonated fluid to the semiconductor device manufacturing component; and (3) cleaning the semiconductor device manufacturing component with the ozonated fluid.

In a second aspect of the invention, an apparatus adapted to clean a semiconductor device manufacturing component is provided. The apparatus includes an ozone module adapted to (1) obtain Ozone; (2) combine the Ozone with a fluid to generate ozonated fluid; and (3) deliver the ozonated fluid to the semiconductor device manufacturing component so as to clean the semiconductor device manufacturing component. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE DRAWINGS

FIG. 1 illustrates a schematic layout of an embodiment of an ozonated fluid cleaning system provided in accordance with the present invention.

### DETAILED DESCRIPTION

The present invention provides systems and methods for controlling bacteria in wet processing systems. According to the present invention, a cleaning system is provided that utilizes ozonated de-ionized water or another cleaning solution capable of cleaning bacteria in a semiconductor device manufacturing component (e.g., a Heat Exchanger, a pump such as a clean dry air (CDA) pump or other pump, a Liquid Delivery Module, a wet processing system, a planarization device such as a chemical mechanical polishing (CMP) device, etc.). The cleaning system may be a closed loop system and/or may be enclosed in a cabinet (e.g., a ventilated chemical cabinet). In some embodiments, the cleaning system may be a self-contained unit that may be portable and capable of being applied to any number of appropriate semiconductor device manufacturing components for cleaning such components. In other embodiments, the cleaning system may be integrated with a semiconductor device manufacturing component.

The cleaning system of the present invention may include one or more devices for generating ozone (e.g., via an ozone generator). The cleaning system may also include one or more retention tanks for retaining a quantity of de-ionized water (“DiW”). Ozone may be flowed into the retention tanks to create ozonated DiW. Additionally or alternatively, using one or more dispersion mechanisms (e.g., injector, diffuser, Y-valve, etc.), the cleaning system may combine DiW with ozone from the ozone generator or another source. In some embodiments, ozone may be combined with ozonated DiW from a semiconductor device manufacturing component to be cleaned before being flowed into the retention tanks. The cleaning system may also include any number of filters capable of filtering bacteria or other impurities from the ozonated DiW in the cleaning system.

The cleaning system of the present invention may also include safety devices and/or interlocks. For example, the cleaning system may include threshold level value or other monitors that measure ozone levels in the cleaning system cabinet, outside the cabinet, and/or at the component being cleaned by the cleaning system. In the same or alternative embodiments, the cleaning system may include flow rate detectors at various locations in the system. Additionally or alternatively, the cleaning system may include an interlock system which may prevent start-up and/or cause shut-down of the cleaning system if adverse conditions are detected (e.g., pump failure, improper ozone level, sensor malfunction, improper flow rate, etc.).

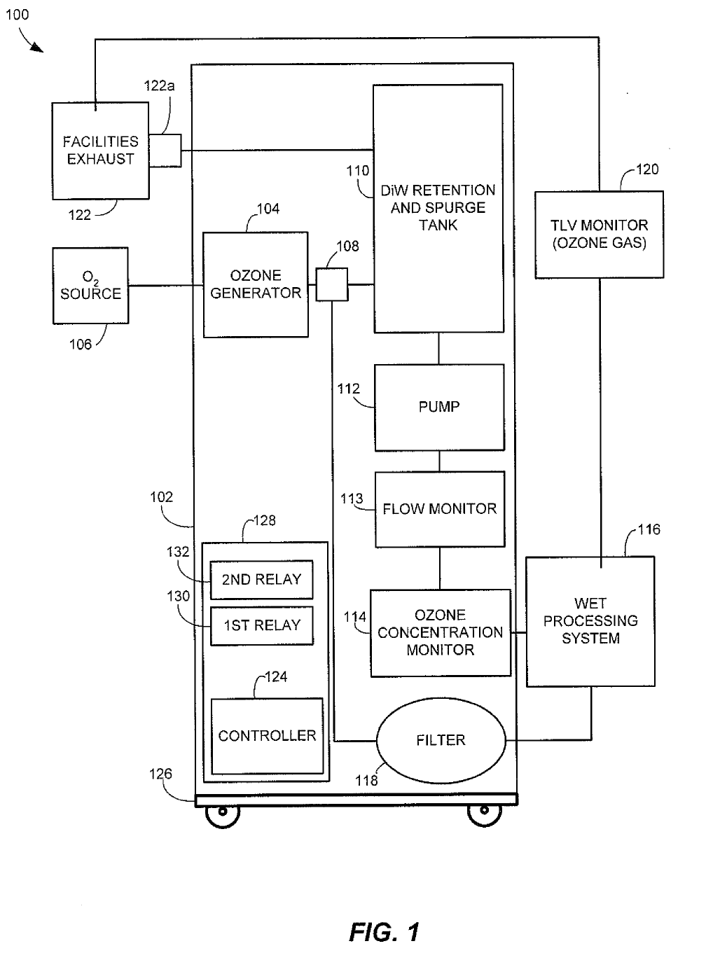

FIG. 1 illustrates a schematic layout of an embodiment of an ozonated de-ionized water cleaning system provided in accordance with the present invention and that is designated generally by reference numeral 100. In the embodiment of FIG. 1, the cleaning system 100 may include a cabinet 102, which may contain an ozone generator 104. The ozone generator 104 may be supplied oxygen by oxygen source 106 (which may reside in or outside of the cabinet 102). The cabinet 102 may also contain a valve 108 that may receive ozone from the ozone generator 104 and/or deionized water (as described below) and control flow of ozone and/or deionized water (DiW) to a tank 110 in which ozone and DiW form ozonated DiW.

Ozonated DiW may be pumped from tank 110 by a pump 112, monitored by a flow monitor 113, an ozone concentration monitor 114, etc., and flow to a semiconductor device manufacturing component 116 to be cleaned (e.g., a wet processing system or another component). The ozonated DiW flows through the component 116, is filtered via one or more filters or other cleaning mechanisms (e.g., filter 118) and is recirculated back to the tank 110 via the valve 108.

An ozone gas monitor 120 may be coupled to a facilities exhaust 122 and/or to other relevant locations within the cleaning system 100 and/or to the semiconductor device manufacturing component to be cleaned (e.g., a wet processing system) for measuring and/or monitoring ozone levels therein.

A controller 124 may be employed to control operation of the cleaning system 100 as described further below. The controller 124 may be coupled to one or more of the ozone generator 104, the O₂ source 106, the valve 108, the tank 110, the pump 112, the flow monitor 113, the ozone concentration monitor 114, the ozone gas monitor 120, the facilities exhaust 122, etc., and control operation thereof.

In the exemplary embodiment of FIG. 1, the cabinet 102 may be supported on a stationary or mobile cart 126 and/or may be a mobile unit or “ozone cart”. The cabinet 102 may be, for example, a ventilated chemical cabinet and may be capable of containing any gases which may build up inside the enclosed cabinet 102. The cabinet 102 may also be capable of ventilating (e.g., releasing and/or pumping) gases to an external location, such as the facilities exhaust system 122 (discussed below). In at least one embodiment, the cabinet 102 may be a double cabinet type structure (e.g., a double walled and/or double containment cabinet). For example, the cabinet 102 may include an outer and inner cabinet (not separately shown) which may each be independently sealable. The cabinet 102 may be constructed of any suitable materials (e.g., stainless steel (SST), PVDF, PVA, polytetrafluoroethylene such as Teflon® available from Dupont, etc.).

In some embodiments, ozone generator 104 may be enclosed in cabinet 102 and may capable of producing ozone. Ozone generator 104 may be any appropriate ozone generator. For generation of ozone, ozone generator 104 may receive oxygen from the oxygen source 106. Oxygen source 106 may be a bottled O₂ source, an oxygen generator, environmental air, or any other appropriate source.

Valve 108 may be capable of receiving ozone from the ozone generator 104 or any other appropriate source and may be contained within the cabinet 102. In an exemplary embodiment, the valve 108 is capable of mixing ozone with a fluid, preferably DiW. The valve 108 may be any appropriate valve, such as a venturi-type injector, a diffuser, a Y-valve, or the like. In an exemplary embodiment, the valve 108 may force DiW through a conical body, which initiates a pressure differential between an inlet port and an outlet port of the valve 108. This pressure differential creates a vacuum inside an injector body, which initiates ozone suction through a suction port coupled to the ozone generator 104.

The valve 108 may receive a fluid, such as DiW, from the component 116 to be cleaned or another DiW source. As stated, the component 116 may be a Heat Exchanger, a CDA pump, a Liquid Delivery Module, a wet processing system or the like.

The combination of ozone and DiW may be flowed from the valve 108 into the tank 110. The tank 110 may be any suitable retention tank of any suitable size (e.g., 6 gallon, 8 gallon, etc.). The tank 110 may also function as a “spurge” tank. For instance, the tank 110 may contain a quantity of DiW through which ozone may be flowed. Flowing ozone through the DiW may cause the ozone to be suspended in, dissolved in, or otherwise combined with the DiW, creating ozonated DiW. Ozone flowed through the DiW and/or other gases may collect at the top of the tank 110 and/or may be purged from the tank 110 (e.g., pumped or siphoned).

Tank 110 may be contained within and/or removable from the cabinet 102. The tank 110 may be removable to drain, change, and/or flush DiW and/or other fluids and/or gases therefrom. A drain, inlets, and/or other appropriate devices (not shown) may be connected to the tank 110 to add and/or remove fluid and/or gas to/from the tank 110.

As stated, ozonated DiW may be pumped from the tank 110 by pump 112. The pump 112 may be an electrical pump or any other appropriate pump. The pump 112 may be contained within the cabinet 102 or may be external to the cabinet 102. In an exemplary embodiment, the flow rate of the pump 112 may be above about 0.4 gallons per minute. Other flow rates may be used.

Pump 112 may pump the ozonated DiW through the flow meter 113 and the ozone monitor 114. Any suitable flow meter 113 may be used (e.g., a mass flow controller, a need valve, etc.).

The ozone concentration monitor 114 may be capable of measuring the ozone concentration in the ozonated DiW. For example, the ozone concentration monitor 114 may be capable of detecting concentrations of parts per million (PPM), preferably concentrations above about 4 PPM. In an exemplary embodiment, ozone concentrations may be between about 6 and 10 PPM during the cleaning process. Other ozone concentrations may be used. Any suitable ozone monitor may be used.

After pump 112 pumps the ozonated DiW through the ozone monitor 114, the ozonated DiW may be pumped into (e.g., through) the component 116 to be cleaned. In an exemplary embodiment, the component 116 may be a portion of a wet cleaning processing system, such as a Heat Exchanger, CDA pump, Liquid Delivery Module, CMP device, semiconductor device manufacturing tool, or related structures and systems. Other wet cleaning processing systems and/or other components may be similarly cleaned.

Ozonated DiW pumped through a wet cleaning processing system (e.g., component 116) may contain impurities such as bacteria removed from the wet cleaning processing system as the system is cleaned by the ozonated DiW. After passing through the wet cleaning processing system, the ozonated DiW may be pumped or flowed through the filter 118. In at least one embodiment, filter 118 may be capable of filtering particles greater than about 0.2 microns in size, although any appropriate filtering criteria may be used. Additional filters 118 may be disposed elsewhere in the cleaning system 100, as appropriate.

After flowing through the filter 118, the ozonated DiW may be flowed into the valve 108, creating a closed loop system.

As stated, the cleaning system 118 may include one or more ozone gas monitors 120. In the exemplary embodiment of FIG. 1, an ozone gas monitor 120 may be disposed outside the cabinet 102. In an alternative embodiment, the ozone gas monitor 120 may be disposed inside the cabinet 102 or an additional ozone gas monitor may be disposed inside the cabinet 102. Each ozone gas monitor 120 may, for example, be a threshold level value (TLV) monitor capable of measuring a threshold level of about 0.10 PPM, for example. Each ozone gas monitor 120 may include an alarm or shut down initiator which may be activated at about half of the threshold value (e.g., at about 0.05 PPM). For example, an ozone gas monitor may signal the controller 124 to initiate an alarm condition or system shut down. Other threshold values and/or alarm conditions may be used. The ozone gas monitor(s) 120 may be adapted to monitor levels of ozone gas throughout the cleaning system 100 and/or outside the system (e.g., with sensor, or “sniff”, lines). For example, the ozone gas monitor(s) 120 may be capable of monitoring ozone gas levels inside the cabinet 102, in the tank 110, at the facilities exhaust 122, at the component 116, and/or at any other appropriate location. Any suitable ozone monitor may be employed.

Exhaust at the facilities exhaust 122 may be monitored by a pressure monitor 122a. The pressure monitor 122a may include, for example, a pressure gauge with high and low set points. Thus, the pressure monitor 122a may be used to determine if sufficient exhaust flow is occurring to/at the facilities exhaust 122. Absence of, or insufficient exhaust flow may cause an alarm condition and/or may disable or initiate shut-down of the cleaning system 100 (e.g., via a signal sent to the controller 124). Any suitable pressure monitor may be used.

Flow of the ozonated DiW may be monitored at any point or points in the cleaning system 100 by the flow monitor 113 or another flow monitor, such as before or after the pump 112, the component 116, the tank 110, etc. Each flow monitor may be capable of measuring the flow rate and/or determining if the flow rate is sufficient for system use. For example, if the flow rate is insufficient (e.g., below a threshold value), the cleaning system 100 may be caused to shut-down or may not be permitted to initiate operation. For example, a flow monitor may signal the controller 124 to initiate an alarm condition or system shut down. In an exemplary embodiment, a minimum flow rate of about 0.4 gallons per minute may be required, although any appropriate flow rate may be used. In some embodiments, each flow monitor may be capable of measuring a flow rate of between about 0.03 and 3 gallons per minute. Any number of flow monitors may be used to monitor ozonated DiW flow at any point in the cleaning system 100. Any suitable flow rate monitor may be employed.

In an alternative embodiment, the tank 110 need not be connected to a facilities exhaust 122. For example, gases exhausted from the tank 110 may flow through a series of (e.g., one or more) inline carbon or other filters (now shown). The inline carbon filters may serve to filter ozone present in the exhausted gases. In some embodiments, the inline carbon filters may flow the filtered gases to an ozone monitor, such as the ozone monitor 120 for testing and detection (e.g., to ensure that high levels of ozone are not exhausted by the system).

The cleaning system 100 may include an interlock safety system 128. The interlock safety system 128 may monitor various aspects of the cleaning system 100 and may provide control over the system. For example, the interlock safety system may prevent the cleaning system 100 from starting up, may shut the system down, and/or may cause an alert condition (e.g., an alarm or other notification). In one exemplary embodiment, the interlock safety system may be initiated by start up of the pump 112 (e.g., the depression of a start button). When sufficient flow rate through the pump 112 has been achieved (e.g., the flow rate is above about 0.4 GPM), an initial start relay 130 may remain on. In some embodiments, a second start button may be depressed, and a second start button relay 132 may remain on after one or more other thresholds and/or levels of operation of the cleaning system 100 have been determined to be within the proper operating range. In an exemplary embodiment, five levels may be monitored. Exemplary levels are exhaust flow, ozone threshold value inside the cabinet 102, ozone threshold value outside the cabinet 102, proper operation of the ozone gas monitor 120, and ozonated DiW flow rate. The threshold levels and flow rates may be adjusted as appropriate for the system. Other types and/or numbers of operating levels and/or thresholds may be monitored.

In some embodiments, the controller 124 may monitor the states of the pump 112, exhaust flow, ozone threshold value inside and/or outside the cabinet 102, proper operation of the ozone gas monitor(s) 120, ozonated DiW flow rate, etc., and limit and/or prevent operation of the system 100 when any system device (e.g., the pump to 112) is not functioning properly and/or any level is outside a predetermined range or tolerance.

As stated, the controller 124 may be coupled to one or more of the pressure (exhaust) monitor(s), flow monitor(s), ozone gas and/or concentration monitor(s) and/or other sensors/monitors of the cleaning system 100. The controller 124 may, for example, monitor operation and/or readings of the above monitors, and/or control operation of the cleaning system 100. The controller 124 may include hardware, software or a combination of the same (e.g., one or more appropriately programmed microcomputers and/or microcontrollers).

It will be understood that additional or alternative solutions may be used in conjunction with the cleaning system 100. For example, DiW may be replaced or supplemented with an alternative cleaning solution, such as a 10% hydrogen peroxide solution (creating an ozonated hydrogen peroxide combination). Other percentage solutions of hydrogen peroxide may be used. Additionally or alternatively, the ozonated DiW or the ozonated hydrogen peroxide solution may be heated to affect destruction of bacteria. In an exemplary embodiment the ozonated fluid may be heated to a range of about 50 to 60 degrees Celsius. In an alternative embodiment, the ozonated fluid may be heated to a range of about 75 to 80 degrees Celsius, although any other appropriate range may be used. In still other embodiments, the DiW or hydrogen peroxide solution may not be combined with ozone, but may be heated to a temperature of about 75 to 80 degrees Celsius, although any other appropriate range may be used.

Use of the cleaning system 100 and the methods described above may be preceded or followed by other cleaning methods. For example, a “high flush” of about five gallons of 10% hydrogen peroxide solution may be flushed in a closed loop through the component 116. The hydrogen peroxide solution may be pumped through the component to be cleaned for about two hours, although any appropriate flush time may be used. This flush may be followed by a purge with nitrogen or another suitable gas. This high flush and/or nitrogen purge may be used before and/or after a cleaning with the ozonated fluid. Other percentages and/or amounts of hydrogen peroxide solution may be used.

Similarly, a 10% or other percentage hydrogen peroxide solution may be used to soak the component 116 before and/or after the ozonated DiW cleaning. For example, the component 116 may be filled partially or fully with the hydrogen peroxide solution and allowed to soak for an appropriate length of time (e.g., about 4 to 8 hours). In some embodiments, the soak may be followed with a nitrogen purge. Additionally or alternately, a soak and/or purge cycle may precede and/or follow the high flush and/or ozonated DiW (or ozonated hydrogen peroxide) cleanings as described above.

In another embodiment, prior to ozonation of the DiW or hydrogen peroxide solution, a UV lamp may be used to treat the DiW. This treatment may cause destruction of bacteria prior to the introduction of ozone into the fluid and may be used as a pre-cleaning.

The cleaning with ozonated fluid described above may be preceded and/or followed with any of the described cleaning methods or any other suitable cleaning methods. For example, the ozonated fluid cleaning may include a flush for about 10 to 40 minutes, which may be followed by a flush or soak of non-ozonated DiW and/or hydrogen peroxide solution. Another cycle of cleaning with ozonated fluid for about 10 to 40 minutes may follow this flush or soak.

The foregoing description discloses only exemplary embodiments of the invention; modifications of the above disclosed methods and apparatus which fall within the scope of the invention will be readily apparent to those of ordinary skill in the art. For example, any number of ozone generators, valves, pumps, tanks, monitors, and/or filters may be used. Additionally, the cleaning system may be used with more than one semiconductor device manufacturing component at a time or may be integrated into a semiconductor device manufacturing component.

In at least one embodiment, production of ozone by the ozone cart and/or cabinet 102 may be limited to less than about 0.5 lbs/day. Vacuum may be employed to remove residual water from system lines (e.g., prior to ozone exposure). For example, an N2 purge, vacuum, N2 purge sequence may be used to remove water from lines and/or dead legs of the cleaning system 100 and/or the component(s) to be cleaned. In some embodiments, non-metal (stainless steel) manifolds may be employed for distributing water to and from an ozone unit. For example, PVDF, PFA, Teflon®, stainless steel 316L, etc., may be used for the cart and/or the mix tank may be made from PVDF.

In at least one embodiment of the invention, the cleaning system 100 may be portable and used to clean an entire semiconductor device manufacturing tool and/or system. For example, the cleaning system 100 may be connected to the fluid lines of a wafer cleaning system and used to clean all components of the wafer cleaning system (e.g., by pumping ozone through the entire system such as through scrubbers, megasonic tanks, liquid delivery modules, spin rinse dryers, polishers, or any other fluid path).

In some embodiments, one or more additional filters may be employed to filter the ozonated DiW after it leaves the tank 110 (e.g., to remove any particulates or sediment in the ozonated DiW). For example, ozonated DiW may be flowed through a filter after leaving the tank 110, either before or after the pump 112).

In some embodiments, an ozone module (e.g., a portable ozone module such as an ozone cart, a stationary ozone module, an ozone module integrated with a semiconductor device manufacturing component, etc.), may be adapted to remove bacteria from the semiconductor device manufacturing component. The ozone module also may be adapted to heat the ozonated fluid before supplying the ozonated fluid to the semiconductor device manufacturing component, such as via one or more heaters (not shown) coupled to a supply line or the like, located inside or outside of the ozone module.

In at least one embodiment, the ozone module is adapted to flush the semiconductor device manufacturing component with a cleaning solution before and/or after supplying the ozonated fluid to the semiconductor device manufacturing component. For example, the cleaning solution may include Hydrogen Peroxide or another suitable chemical. Further, the ozone module may be adapted to purge the semiconductor device manufacturing component with a gas (e.g., Nitrogen, Argon, etc.) after flushing the semiconductor device manufacturing component. As stated, the ozone module may be adapted to recirculate ozonated fluid used to clean the semiconductor device manufacturing component.

Accordingly, while the present invention has been disclosed in connection with exemplary embodiments thereof, it should be understood that other embodiments may fall within the spirit and scope of the invention, as defined by the following claims.

The invention claimed is:

1. An apparatus adapted to clean a semiconductor device manufacturing component comprising:
an ozone module adapted to:
obtain Ozone;
combine the Ozone with a fluid to generate ozonated fluid; and
deliver the ozonated fluid to the semiconductor device manufacturing component so as to clean the semiconductor device manufacturing component.

2. The apparatus of claim 1, wherein the ozone module is portable.

3. The apparatus of claim 1, wherein the ozone module includes:
an ozone generator adapted to generate Ozone from an Oxygen source;
a valve adapted to combine the Ozone from the ozone generator and the fluid to form the ozonated fluid;
a retention tank adapted to store the ozonated fluid; and
a pump adapted to pump ozonated fluid from the retention tank to the semiconductor device manufacturing component so as to clean the semiconductor device manufacturing component.

4. The apparatus of claim 3, further comprising a cabinet that surrounds the ozone generator, valve, retention tank and pump so as to form a portable ozone module.

5. The apparatus of claim 4 wherein the cabinet is a double-walled cabinet.

6. The apparatus of claim 3, wherein the ozone module further comprises a controller adapted to:
monitor one or more of a state of the pump, a level of exhaust flow from the ozone module, a level of ozone inside the ozone module, a level of ozone outside the ozone module and a level of ozonated fluid flow rate; and
limit operation of the ozone module if the pump is not functioning properly or any monitored level is outside a predetermined range.

7. The apparatus of claim 3, wherein the ozone module further comprises a controller adapted to:
monitor one or more of a state of the pump, a level of exhaust flow from the ozone module, a level of ozone inside the ozone module, a level of ozone outside the ozone module and a level of ozonated fluid flow rate; and
generate an alarm if the pump is not functioning properly or any monitored level is outside a predetermined range.

8. The apparatus of claim 1, wherein the ozonated fluid comprises de-ionized water.

9. The apparatus of claim 8, wherein the de-ionized water is supplied from the semiconductor device manufacturing component.

10. The apparatus of claim 1, wherein the ozonated fluid comprises Hydrogen Peroxide.

11. The apparatus of claim 1, wherein the Ozone is combined with the fluid in a tank.

12. The apparatus of claim 1, wherein the Ozone is combined with the fluid in a valve.

13. The apparatus of claim 1, wherein the ozone module is adapted to remove bacteria from the semiconductor device manufacturing component.

14. The apparatus of claim 1, wherein the ozone module is adapted to heat the ozonated fluid before supplying the ozonated fluid to the semiconductor device manufacturing component.

15. The apparatus of claim 1, wherein the ozone module is adapted to flush the semiconductor device manufacturing component with a cleaning solution at least one of before and after supplying the ozonated fluid to the semiconductor device manufacturing component.

16. The apparatus of claim 15, wherein the cleaning solution comprises Hydrogen Peroxide.

17. The apparatus of claim 16, wherein the ozone module is adapted to purge the semiconductor device manufacturing component with a gas after flushing the semiconductor device manufacturing component.

18. The apparatus of claim 17, wherein the gas comprises Nitrogen.

19. The apparatus of claim 1, wherein the ozone module is adapted to recirculate ozonated fluid used to clean the semiconductor device manufacturing component.

20. The apparatus of claim 3, further comprising one or more filters adapted to selectively filter the ozonated fluid.
